(19) United States
(12) Patent Application Publication
(10) Pub. No.: US 2022/0286917 A1
(43) Pub. Date: Sep. 8, 2022

(54) 5G SERVICE MANAGEMENT IN MULTI-DWELLING UNIT

(71) Applicant: INSEEGO CORP., San Diego, CA (US)

(72) Inventors: CHRISTOPHER YEATTS, San Diego, CA (US); Mikko Jaakkola, San Diego, CA (US); Sangram Tidke, San Diego, CA (US)

(21) Appl. No.: 17/685,813

(22) Filed: Mar. 3, 2022

Related U.S. Application Data
(60) Provisional application No. 63/156,784, filed on Mar. 4, 2021.

(51) Int. Cl. H04W 28/24; H04W 28/20; H04W 4/24; H04W 28/02

(52) U.S. Cl. CPC H04W 28/24; H04W 28/20; H04W 4/24; H04W 28/0268

(57) ABSTRACT

Systems and methods are described herein for 5G service management in a multi-dwelling unit, including updating a FWA device and/or the switch to create further specialized devices for the network. For example, the FWA device can obtain service to the 5G network from a 5G small cell (e.g., gNodeB, base stations, etc.) and then determine throughput or 5G Quality Of Services (QoS) for each home GW or AP of the multi-dwelling unit. Software agents or applications may reside on various locations, including the FWA device/modem, switch, cloud (e.g., local cloud, central cloud, etc.), and home GW/APs to determine bandwidth and QoS provided to each AP using traffic shaping algorithm. Alternative embodiments may include: (1) integrating with a billing system of the service provider (e.g., ISP, etc.) where the FWA device can transmit data used via the 5G communication network or (2) the FWA device acts as a virtual carrier.

### CROSS REFERENCE TO RELATED APPLICATIONS

This non-provisional patent application claims priority to U.S. Patent Application No. 63/156,784, filed on Mar. 4, 2021, the contents of which is incorporated herein by reference in its entirety.

### TECHNICAL FIELD

The present disclosure relates generally to 5G fixed wireless access (FWA) devices, and in particular, to 5G service management in a multi-dwelling unit.

### DESCRIPTION OF RELATED ART

Wireless communications have become ubiquitous in today's society as wireless systems capabilities increase so does the adoption rate of wireless technologies. Today, wireless technologies are fast overtaking and replacing conventional wired technologies and infrastructure.

The 5G broadcast transmission protocol devised by the 3^{rd} Generation Partnership Project (3GPP) represents the latest in wireless communication technologies promising to revolutionize wireless data communications. 5G high-band technologies utilize extremely high frequency (EHF), or millimeter wave, that enables connectivity significantly improved over the previous generation 4G networks. 5G provides greater spectral efficiency and greater spectrum pathways to achieve increased throughput for each part of the spectrum.

While millimeter wave frequencies allow greater bandwidth, these frequencies suffer from decreased range as compared to their longer wavelength, lower frequency predecessors. Millimeter wave frequencies also suffer from greater attenuation when traveling through walls, windows and other structural components. Accordingly, 5G networks typically require a higher density of transmitters as compared to 4G network architectures.

### BRIEF DESCRIPTION OF THE DRAWINGS

The technology disclosed herein, in accordance with one or more various embodiments, is described in detail with reference to the following figures. The drawings are provided for purposes of illustration only and merely depict typical or example embodiments of the disclosed technology. These drawings are provided to facilitate the reader's understanding of the disclosed technology and shall not be considered limiting of the breadth, scope, or applicability thereof. It should be noted that for clarity and ease of illustration these drawings are not necessarily made to scale.

FIG. 1 illustrates an example 5G network with which various embodiments of the present disclosure may be implemented.

FIG. 2 illustrates an example of an in-home wireless and wired network with which various embodiments may be implemented.

FIG. 3 illustrates an example of a multi-dwelling unit with wireless and wired network with which various embodiments may be implemented.

FIG. 4 illustrates a schematic representation of an example FWA device in communication with devices of a multi-dwelling unit with which various embodiments may be implemented.

FIGS. 5-8 illustrate systems and processes for data usage tracking and aggregation in the multi-dwelling unit with which various embodiments may be implemented.

FIG. 9 illustrates an example computing component capable of executing instructions for implementing 5G service management in accordance with one embodiment of the disclosed technology.

FIG. 10 illustrates an example computing component capable of executing instructions for implementing 5G service management in accordance with one embodiment of the disclosed technology.

FIG. 11 is an example computing component that may be used to implement various features of embodiments described in the present disclosure.

The figures are not exhaustive and do not limit the disclosure or the disclosed embodiments to the precise form disclosed.

### DETAILED DESCRIPTION OF THE EMBODIMENTS

5G technology provides, for example, home broadband services over cellular networks, through the use of Fixed Wireless Access (FWA) and other specialized devices. FWA can refer to accessing a communications network or internet via fixed wireless networks in order to provide 5G home broadband service over cellular networks. In many FWA implementations, wireless broadband data communication is effectuated between two fixed locations that are connected by FWA devices and/or equipment. FWA may be useful in areas where implementing wired broadband access (e.g., laying cable/wire, etc.) is prohibitively expensive, impractical, and the like, especially in densely populated areas. In areas were wired broadband access already exists and/or would be cheap to implement, FWA may still be used to support Virtual Networks (e.g., VLANs), Software-Defined Networking (SDN) and/or Network Function Virtualization (NFV) in a Wide Area Network (WAN) with traffic bursting, as a backup to existing networks, etc.

In these densely populated areas, many user devices initiate connections to the network in a multi-dwelling unit, but with technological limitations. For example, the frequency of mmWave signals are so high that they cannot penetrate most building materials, e.g., cement or brick, or is attenuated/reflected so much that its utility is lost (e.g., on the order of above 20-50 dB). Even propagation through air results in signal loss, thereby limiting the efficacy of mmWave to smaller areas as alluded to above. Moreover, mmWave signals have poor multipath propagation. Factors that may compound these issues include, for example, a common desire by end users to place equipment wherever they desire (for convenience, aesthetics, etc.).

In accordance with various embodiments, multiple devices may send and receive data in a multi-dwelling unit, and/or provide collective network access to these devices. The devices that enable the 5G network access may comprise, for example, a FWA device (e.g., outside the multi-dwelling unit), switch (e.g., inside a main point of access (MPOE) of the multi-dwelling unit), and one or more gateways (GWs) or access points (APs) (e.g., inside each user's unit of the multi-dwelling unit). For example, the FWA device may receive 5G broadband service from a 5G small cell of the communication network, where the 5G communications are received by the FWA device being communicatively coupled with a 5G small cell. The FWA device may transmit electronic communications to the multi-dwelling unit via a switch (e.g., a networking switch with or without VLANs, network router, and SDN functionality, etc.). The switch may be communicatively linked or paired to multiple GWs or APs connected with units in the multi-dwelling unit. Each of the GW/AP devices can be communicatively linked to user devices in the unit to provide 5G broadband service to each device.

However, with this combination of devices, access to 5G broadband services and data transmitted via the 5G communications network may be difficult to distinguish for individual units and user devices in the multi-dwelling unit. For example, in traditional systems, individual devices may each establish access to the 5G network through an internet service provider (ISP) or other mobile carrier. The traditional billing solutions may rely on one-to-one access between the user device and the ISP. This may be unreasonable for use with the FWA device and switch, at least because the user devices in each unit would use the functionality of the FWA device and the switch to access the 5G broadband services within the multi-dwelling unit. The 5G access would correspond with different metrics (e.g., Quality of Service (QoS), transmission rates, etc.), while the cost of the FWA device and the switch would be put on the owner of the multi-dwelling structure.

In some embodiments, the FWA device and/or the switch can be updated to create further specialized devices. For example, the FWA device can obtain service to the 5G network from a 5G small cell (e.g., gNodeB, base stations, etc.) and then determine throughput or 5G Quality Of Services (QoS) for each home GW or AP of the multi-dwelling unit. Billing can be dependent upon how the traffic shaping is implemented (e.g., to effectuate the determined throughput/QoS). This is distinguishable from other systems that monitor usage at an end-user device (e.g., at each individual AP/home GW) or billing a flat fee to multiple users of a single FWA device. In some embodiments of the application, users can avoid having to create separate accounts with an ISP (e.g., based on each home GW/AP) or rely on blind billing, since the FWA is able to mete out service and users can be charged based on that traffic-shaped service that is determined for them.

In some examples, systems and/or methods may implement a smart billing and service management of FWA devices in a multi-dwelling unit (MDU). The received signal may be split using the FWA device or switch, which distributes the wireless signal to home GW/APs in the MDU by means of Wi-Fi, Ethernet, power-line, cable, etc.

Software agents or applications may reside on various locations, including the FWA device/modem, switch, cloud (e.g., local cloud, central cloud, etc.), and home GW/APs to determine bandwidth and QoS provided to each AP using traffic shaping algorithm. Alternative embodiments may include: (1) integrating with a billing system of the service provider (e.g., ISP, etc.) where the FWA device can transmit data used via the 5G communication network or (2) the FWA device acts as a virtual carrier. Software agents or applications on each FWA device, switch, and the AP/GW can communicate with either the service provider's system or a central system associated with the 5G communication network to provide the data used to a shared repository. Traffic shaping may also be implemented by the FWA device or the switch with the assistance of the GW/AP and the central system.

A user of the GW/AP may be charged depending on the speed that is being delivered to them and total usage by the GW/AP. Alternative embodiments may include: a flat fee or combination of data used and flat fee by the GW/AP. For example, one unit within the MDU could pay for their usage based on usage (e.g., $29.99 per month for up to 5 GB of data and then pay for overages if they exceed the 5 GB) while another could pay more for an unlimited plan.

In some embodiments, the user of the GW/AP may be charged depending on the Quality of Service (QoS) or Quality of Experience (QoE). In these implementations, the FWA device or GW/AP may tag different types of traffic as different QoS categories and compare the data usage to a QoS threshold. The QoS categories may include, for example, audio, video, telephonic, near real-time, real-time (e.g., video-conferencing), data streaming (e.g., television), and the like. One or more data types may be tagged into the same QoS category (e.g., video). The QoS categories may correspond with different ranges of QoS (e.g., television streaming may have a larger range of QoS to tolerate bigger fluctuations) due to expected components of the data stream (e.g., buffering). The system may allocate the data capacity and the traffic time to the user ahead of time, as well as implement real-time adjustments based on Quality of Experience (QoE) or other measurements.

Quality of Experience (QoE) may attempt to objectively measure a user's impression of the 5G network service (e.g., web browsing, phone call, TV broadcast) by measuring service parameters. QoE may include system, human, and contextual factors. System factors may include encoding, resolution, sample rate, bandwidth, delay, jitter, screen resolution, display size, and the like. Human factors may include visual and auditory acuity, gender, age, mood, cognitive processes, socio-cultural and economic background, expectations, needs and goals, and other personality traits. Contextual factors may include location, space, time of day, frequency of use, inter-personal relations during experience, economic factors, multitasking, interruptions, task type, technical or informational relationships between systems, and the like. In comparison with a QoS measurement, which is most of the time not related to a user but to the media or network itself, QoE may be more of a subjective measure from the user's perspective. QoE may help determine the overall quality of the service provided.

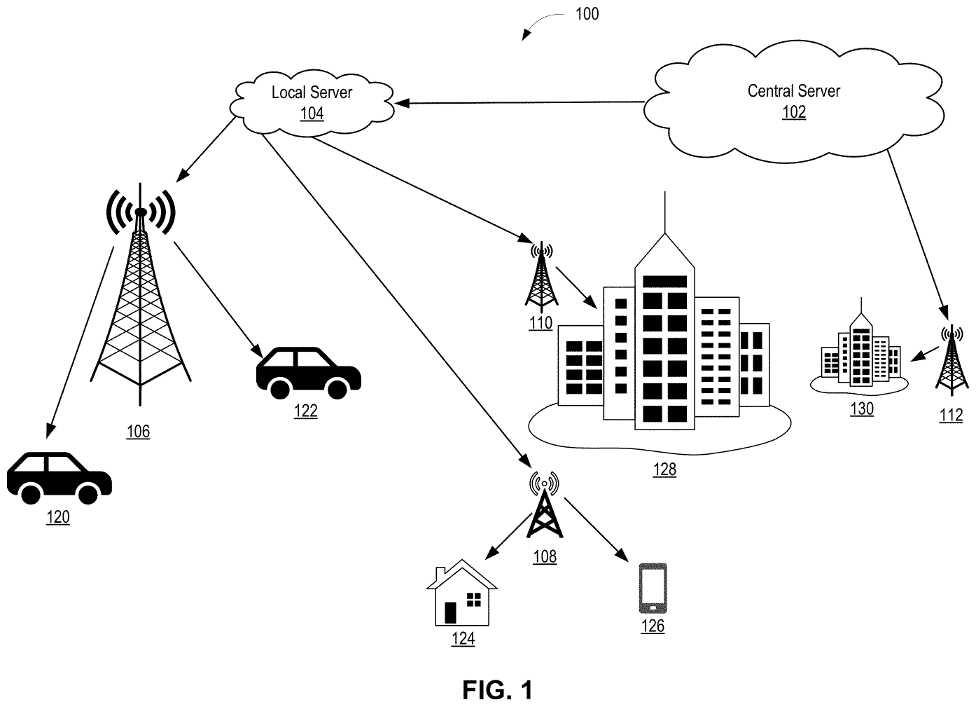

Before describing example embodiments in detail, it is useful to describe an example environment with which various embodiments may be implemented. FIG. 1 illustrates an example 5G network 100 in which or with which various embodiments of the present disclosure may be implemented. 5G is a standard promulgated by the International Telecommunication Union (ITU) and the 3^{rd} Generation Partnership Project (3GPP), with the ITU setting the minimum requirements for 5G compliance, and the 3GPP creating the corresponding specifications. 5G is a successor to the 4G/Long Term Evolution (LTE) standard, and refers to the fifth generation of wireless broadband technology for digital cellular networks. 5G is intended to replace or augment 4G/LTE. Touted advantages of 5G include, for example, up to 10 times faster download and upload speeds, along with much-reduced latency (also referred to as “air latency,” i.e., the roundtrip time it takes for a device to communicate with the network).

The frequency spectrum of 5G includes three bands. The first band can be referred to as the low-band spectrum, i.e., the sub-1 GHz spectrum. This low-band spectrum is the primary band used by U.S. wireless carriers with data speeds reaching about 100 Mbps. The second band can be referred to as the mid-band spectrum, i.e., the sub-6 GHz spectrum, which provides lower latency (e.g., 4-5 ms) and greater data speeds (e.g., up to 1 Gbps) relative to the low-band spectrum. However, mid-band signals are not able to penetrate structures, such as buildings, as effectively as low-band signals. The third band can be referred to as the high-band spectrum, or millimeter wave (mmWave), and operates between 25 GHz and 100 GHz. The term millimeter is associated with this high-band spectrum because wavelengths in this portion of the spectrum range from, e.g., 1-10 mm. Devices operating on this third band can deliver the highest data speed (e.g., up to 10 Gbps) and the lowest latency (e.g., 1 ms). However, its coverage area (e.g., the distance it can transfer data) is less than that of the low-band and mid-band spectrums, and building penetration decreases as the frequency increases. Use of mmWave technology is nevertheless desirable because the low-band and mid-band portions of the spectrum are already heavily congested with, e.g., TV and radio signals, as well as 4G/LTE traffic, and so long as the coverage area can be limited, the benefits of mmWave technology can still be realized.

With reference now to FIG. 1, a mobile Radio Access Network (RAN) may include various infrastructure, e.g., base stations/cell towers, masts, in-home/in-building infrastructure, and the like. The RAN allows users of mobile devices, e.g., smartphones, tablet computers, laptops, vehicle-implemented communication devices (e.g., vehicles having vehicle-to-vehicle (V2V) capabilities), to the core network. The example of FIG. 1 illustrates a plurality of 5G small base stations or small cells and 5G macro base stations or macro cells, i.e., 5G macro cells 106, 110, and 112, and 5G small cell 108.

Macro cells can refer to (tall, high-powered) “macro” base stations/cell towers that are able to maintain network signal strength across long/large distances. 5G macro cells may use Multiple Input, Multiple Output (MIMO) antennas that may have various components that allow data to be sent and/or received simultaneously. In the example 5G network 100 of FIG. 1, 5G macro cell 106 may provide wireless broadband coverage/communications to vehicles 120 and 122. 5G macro cell 110 may provide broadband service to an area, such as a city or municipality 128. Likewise, 5G macro cell 112 may provide broadband coverage to an area, such as a city or municipality 130. The MIMO antennas used by 5G macro cells may comprise large numbers of antenna elements, which can be referred to as massive MIMO, whose size may be comparable to, e.g., 3G and/or 4G base station antennas.

5G small cells 108 can refer to wireless transmitters/receivers implemented as micro base stations designed to provide coverage to areas smaller than those afforded coverage by 5G macro cells 106, 110, and 112, e.g., on the order of about 100 m to 200 m for outdoor 5G small cells. Indoor 5G small cell deployments may be on the order about 10 m. 5G small cells 108 can be mounted or integrated into/onto street lights, utility poles, buildings, etc., and like 5G macro cells 106, 110, and 112, may also leverage massive MIMO antennas. In the example 5G network 100 of FIG. 1, 5G small cell 108 provides broadband coverage to a house or multi-dwelling unit 124 and smartphone 126.

The core network may comprise the mobile exchange and data network used to manage the connections made to/from/via the RAN. As illustrated in FIG. 1, the core network of 5G network 100 may include central server 102 and local server 104. Central server 102 is shown to effectuate broadband service to municipality 130 by way of 5G macro cell 112. Central server 102 may also operatively connect to local server 104, which in turn, provides broadband connectivity by way of 5G macro cells 106 and 110, as well as 5G small cell 108. The use of distributed servers, such as local server 104 can improve response times, thereby reducing latency. The core network may leverage network function virtualization (instantiation of network functions using virtual machines via the cloud rather than hardware) and network slicing (segmentation of 5G network 100 in accordance with a particular application, industry, or other criteria) to provide these lower response times, and provide faster connectivity.

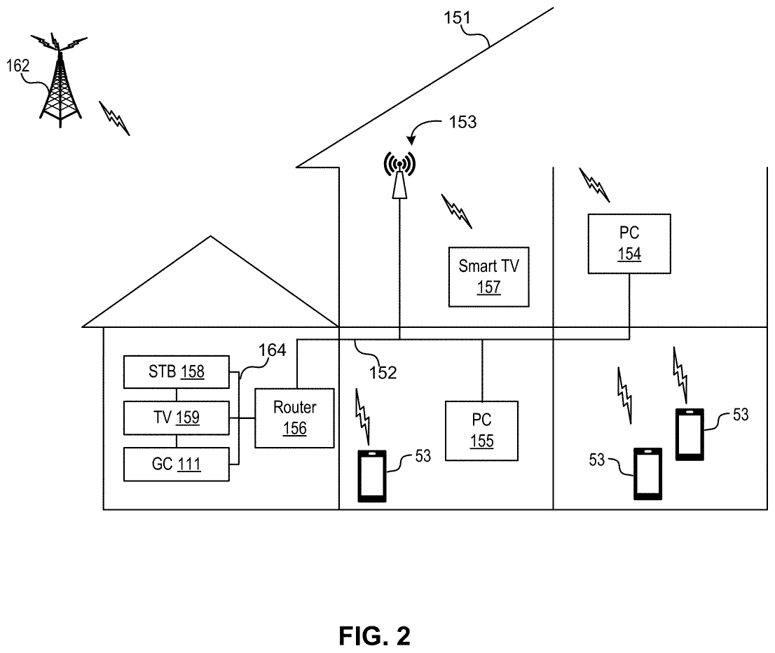

FIG. 2 illustrates an example of an in-home wireless and wired network with which various embodiments may be implemented. The example of FIG. 2 shows a wired and wireless network operating within a building 151 (e.g., multi-dwelling unit 124 or a building in municipality 128 or municipality 130). Building 151 may include a multi-dwelling unit, house, apartment, an office suite or building, a warehouse, a retail establishment or other commercial, residential, or government building.

This example includes a wired network implemented using a wired communications medium 152. In some embodiments, the wired communications medium might be a fiber optic cable system, an Ethernet cable system, a coaxial cable system, a power line system, or other physical communications medium. A gateway (GW) or wireless access point (AP) 153 (used interchangeably) is included in this example to provide a wireless network over which various devices within the building 151 may communicate wirelessly. For example, wireless access point 153 can function as a Wi-Fi router to create a Wi-Fi network over which the various devices can communicate. Wireless access point 153 may also include functionality to communicate with an external network such as, for example, through a 4G or 5G base station 162 (e.g., 5G macro cells 106, 110, and 112 or 5G small cell 108, etc.). In this example, wireless access point 153 also includes a router so that it can communicate over wired communications medium 152.

This example also illustrates a number of devices that can communicate wirelessly or over wired communications medium 152 as devices on the network. This example includes a number of smart phones 53, a smart TV 157, and a personal computer (PC) 154 that can communicate wirelessly with wireless access point 153. This example also illustrates PC 154, PC 155, and router 156 that can communicate with wireless access point 153 via wired communications medium 152. Router 156 can further communicate with set-top box 158, television 159, and gaming console 111 via a wired communications interface 164.

In some implementations, wireless access point 153 may be implemented as a Wi-Fi router for communications with devices within or within proximity of the outside of building 151. Wireless access point 153 may also include a modem such as a 5G modem to communicate with the Internet or other third parties via the 5G communication network. In this manner, the devices in communication with the Wi-Fi or ethernet router of wireless access point 153 may be connected to the Internet or other third parties.

Although various embodiments may be described in terms of this example environment, the technology disclosed herein can be implemented in any of a number of different environments.

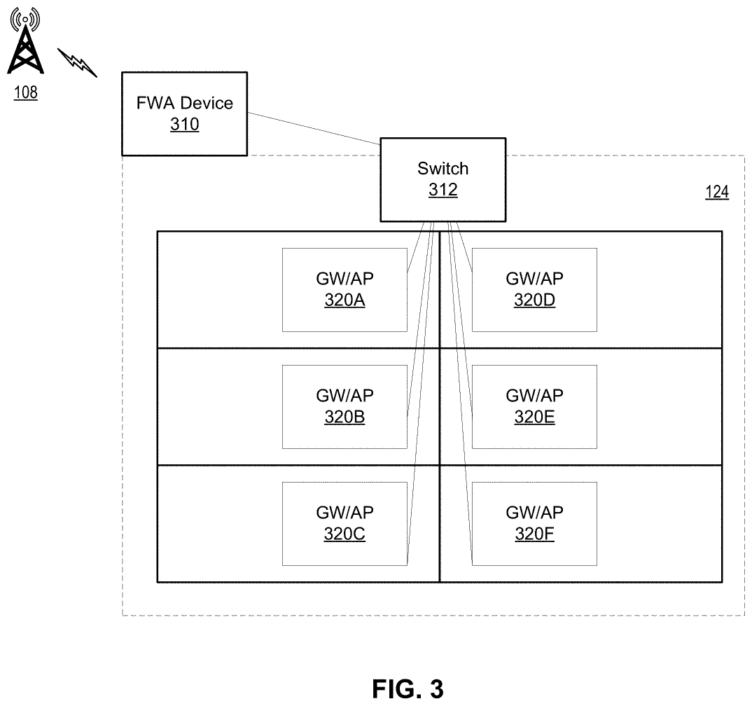

FIG. 3 illustrates an example of a multi-unit dwelling with wireless and wired network with which various embodiments may be implemented. As described herein, 5G small cell 108 can provide 5G broadband coverage to multi-dwelling unit 124. Multi-dwelling unit 124 may comprise FWA device 310 (e.g., outside multi-dwelling unit 124), switch 312 (e.g., inside a main point of access (MPOE) of the multi-dwelling unit), and gateways (GWs) or access points (APs) 320 (e.g., inside each user's unit of the multi-dwelling unit). In some examples, the functionality of switch 312 may be incorporated within FWA device 310 or as a separate device, as illustrated in FIG. 3. In some examples, switch 312 may be incorporated with a cloud router that may take the form of 5G network APN or other cloud router. A plurality of GW/AP 320 devices are illustrated (320A, 320B, 320C, 320D, 320E, 320F), each of which correspond with a unit of a plurality of units in multi-dwelling unit 124.

FWA device 310 may receive 5G broadband service from 5G small cell 108 of the communication network. FWA device 310 may be communicatively coupled with 5G small cell 108 to receive the 5G communications from a local or central server (illustrated in FIG. 1). FWA device 310 may transmit electronic communications to the multi-dwelling unit via an switch 312. Switch 312 may be communicatively linked or paired to multiple GW/AP 320 connected with units in the multi-dwelling unit. Each GW/AP 320 can be communicatively linked to user devices in the unit to provide 5G broadband service to each device.

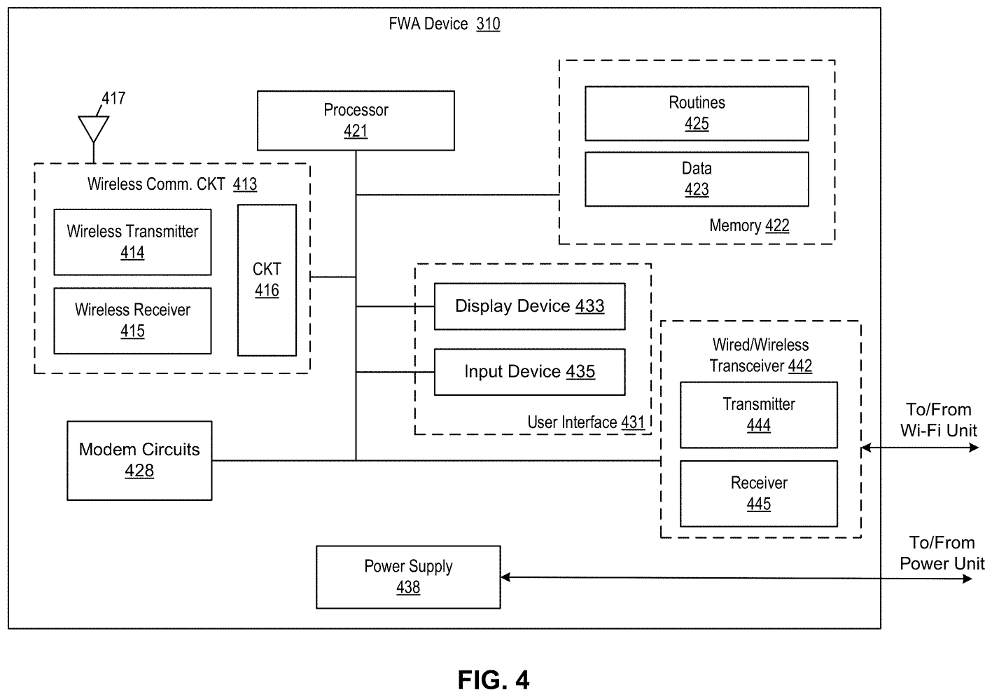

FIG. 4 is an example schematic representation of FWA device 310 that exchanges data (e.g., throughput, QoS, etc.) with switch 312. This example of FWA device 310 includes a processor 421, memory 422, modem circuits 428, power supply circuits 438, and a 5G wireless communication circuit 413. In some embodiments, FWA device 310 may also include user interfaces in the form of a display device 433 and an input device 435. In some embodiments, FWA device 310 may be adapted to store the above-described software application in memory 422, and a processor 421 may execute the application to track throughput or QoS of each unit.

Processor 421 may be implemented as a dedicated or general-purpose processor or combination of processors or computing devices to carry out instructions and process data. For example, processor 421 accesses memory 422 to carry out instructions, including routines 425, using data including data 423. For example, routines 425 may include routines to measure the amount of data received or transmitted from 5G small cell 108 to FWA device 310 and/or run diagnostics, such as determining upload/download speeds and latency, or assigning a performance rating based on multiple signal/channel parameters. That information may be stored as data 423. In some embodiments, routines 425 may include routines to automatically and periodically perform such measurements and/or run such diagnostics. Routines 425 may include routines for responding to commands/instructions received from the application regarding when to initiate measuring of received throughput/QoS. In some embodiments, routines 425 may include routines to transfer such received throughput, QoS measurements to wired or wireless transceiver 442 to be transmitted to the application running on GW/AP or an external application running on a service provider. In an embodiment where the application is executing on FWA device 310, routines 425 may comprise routines for transferring, e.g., throughput, QoS. In some embodiments, routines 425 may include routines for periodically or aperiodically saving measurement and/or diagnostic information as a log, cache, buffering such information, etc.

Processor 421 may include one or more single core, dual core, quad core or other multi-core processors. Processor 421 may be implemented using any processor or logic device, such as a Complex Instruction Set Computer (CISC) microprocessor, a Reduced Instruction Set Computing (RISC) microprocessor, a Very Long Instruction Word (VLIW) microprocessor, a processor implementing a combination of instruction sets, or other processing device. Other modem circuits 428 may be provided to perform other modem functions.

Memory 422 includes memory locations for storing instructions or other routines 425 and data 423. Memory 422 may be implemented using any machine-readable or computer-readable media to store data and instructions, including volatile and nonvolatile memory. Memory may be implemented, for example, as Read-Only Memory (ROM), Random-Access Memory (RAM), Dynamic RAM (DRAM), Double-Data-Rate DRAM (DDRAM), Synchronous DRAM (SDRAM), Static RAM (SRAM), Programmable ROM (PROM), Erasable Programmable ROM (EPROM), Electrically Erasable Programmable ROM (EEPROM), flash memory or other solid state memory, polymer memory, ferroelectric memory, Silicon-Oxide-Nitride-Oxide-Silicon (SONOS) memory, holographic or other optical storage, or other memory structures. Although memory 422 is illustrated as a separate component in FIG. 4, part or all of memory 422 can be implemented on the same integrated circuit as processor 421 or otherwise form part or all of embedded memory of processor 421.

Wireless communication circuit 413 includes a wireless transmitter 414, a wireless receiver 415, communication circuitry 416, and antenna 417. Communication circuitry 416 may be implemented as a communications processor using any suitable processor logic device to provide appropriate communications operations such as, for example, baseband processing, modulation and demodulation, and other wireless communication operations. Where certain operations such as modulation and demodulation are performed in the digital domain, analog-to-digital and digital-to-analog conversion circuitry can be included to provide the appropriate interfaces between communication circuitry 416 and wireless transmitter 414 and wireless receiver 415.

In this example, transceiver 442 includes transmitter 444, receiver 445, antenna (in wireless transmission embodiments), and associated circuitry allows for wired or wireless communications between FWA device 310, switch 312, and AP/GW 320 over Wi-Fi. In some embodiments, transceiver 442 may include or alternatively comprise other wireless communication mechanisms, e.g., the requisite circuitry/componentry that allow for Bluetooth® communications, Near Field Communications (NFC), Zigbee, other short-range communications, or wired communications between FWA device 310, switch 312, and AP/GW 320.

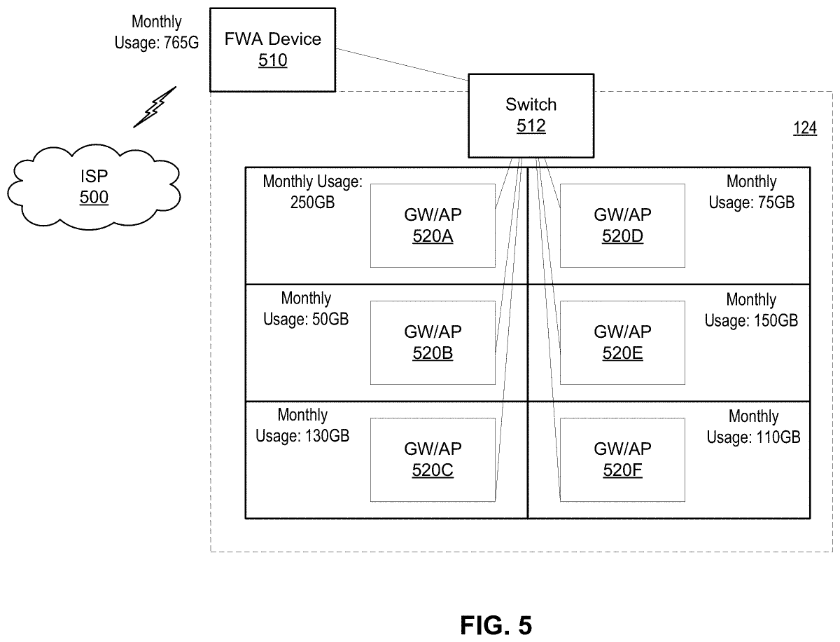

Transceiver 442 may, for example, receive usage information from wireless communications circuit 413 (by way of 5G FWA device 310 connection to 5G small cell 108), which it can transmit via transmitter 444 to GW/AP 320 or switch 312, where a usage tracking application may be running. In some examples, the usage information may remain local at 5G FWA device 310 and processed by routines 425. Additional information on various embodiments of the application are provided with FIGS. 5-8.

In some examples, FWA device 310 incorporates user interface 431 (whether for allowing user the ability to interact with FWA device 310 for billing inquiries, data usage, configuration/troubleshooting purposes, etc.). In this example, user interface 431 may include display device 433 and input device 435. Display device 433 may include, for example, one or more LEDs; display screens, touch screens, or other alphanumeric displays, or other display devices to communicate data or other information to a user. Input device 435 may include buttons, a keypad, a touchscreen display, or other input device to accept input from a user. For example, in some embodiments, voice commands from user may be used to control the self-installation application (if being executed on FWA device 310), and/or audio prompts or other information regarding, e.g., information that might otherwise (or in addition) be presented visually, can be provided to user. Display device 433 and input device 435 may include attendant circuitry such as drivers, receivers and processing or control circuitry to enable operation of the devices with FWA device 310.

Power supply circuit 438 can be included to provide power conditioning or power conversion for components of FWA device 310. For example, power supply can supply power to different components of FWA device 310 at specific voltage and current levels appropriate for those components. Power supply circuit 438 in this example, may receive power from a wired or wireless power source operatively connected to FWA device 310. In some embodiments, power supply 438 may be a battery power supply. In some embodiments, power supply 438 may be Power-over-Ethernet (PoE), where power can be carried over Ethernet wires (IEEE 802.3bt). Some embodiments can incorporate a PoE power injector that can be built into a connected router/gateway, or can be a separate component with an AC adaptor that can be connected to the building mains.

Returning to FIG. 3, FWA device 310 and/or switch 312 is configured to implement a traffic shaping algorithm with the assistance of one or more individual GW/AP 320 and the central system. In some embodiments, traffic shaping may be implemented by identifying data requested by user devices resident to the multi-dwelling unit (e.g., application based traffic shaping). Traffic shaping may alternatively be implemented using a route-based methodology to identify the destination or origination of the data (e.g., as the user devices resident to the multi-dwelling unit).

In some examples, FWA device 310 and/or switch 312 may prioritize or delay metered data traffic such that each packet complies with the traffic shaping rules. Metering may be implemented with, for example, the leaky bucket or token bucket algorithms. Metered packets or cells may be stored in a First In First Out (FIFO) buffer, one for each separately shaped class, until they can be transmitted in compliance with the associated traffic rules. Transmission may occur immediately (e.g., if the traffic arriving at FWA device 310 and/or switch 312 is already compliant), after some delay (e.g., waiting in the buffer until its scheduled release time), or never (e.g., in case of packet loss).

Switch 312 may comprise much of the same hardware configurations as FWA device 310, including a processor, memory, wireless communications circuit, and the like. Switch 312 may also execute machine readable instructions to perform various actions and routines.

Switch 312 may be configured to receive electronic communications to the multi-dwelling unit via FWA device 310. Switch 312 may be communicatively linked or paired to multiple GW/AP 320 connected with units in the multi-dwelling unit. Each GW/AP 320 can be communicatively linked to user devices in the unit to provide 5G broadband service to each device.

Switch 312 is configured to utilize packet switching to receive, process, and forward data between FWA device 310 and multiple GW/AP 320. For example, switch 312 may receive an electronic message and parse the message into independent data packets for transmission to multiple APs/GWs 320, which are reassembled at the user device and/or each GW/AP 320. As such, switch 312 may implement centralized workload provisioning.

In some examples, switch 312 is implemented with a virtualized cloud router that may take the form of 5G network APN or other cloud router. When switch 312 is implemented as a cloud router, switch 312 may process multiple, separate workloads on hardware as multiple routing instances. Each routing instance may separate the management domain with its own protocol stacks and determine data usage for each routing instance. When determining data usage, the user device and/or each GW/AP 320 may transmit and receive data for each dwelling unit that passes through switch 312. The dwelling unit data may be carried inside the building in individual virtual networks (e.g., using 802.1Q tagging) or through individual addresses that are tagged into individual 5G network slices.

Switch 312 is configured to monitor network usage information and detect anomalies by providing a port of entry and exit to each device in the multi-dwelling unit. The usage of the 5G communication network may be tracked and stored (e.g., in a data repository local to switch 312, in data store 423, etc.).

FIGS. 5-8 illustrate various systems and processes for data usage in the multi-dwelling unit.

FIG. 5 illustrates an Internet service provider (ISP) 500 that may communicate with FWA device 510 via the 5G communication network described throughout the disclosure. FWA device 510 may transmit electronic communications to the multi-dwelling unit via switch 512. Switch 512 may be communicatively linked or paired to multiple GW/AP 520 connected with units in the multi-dwelling unit. Each GW/AP 520 can be communicatively linked to user devices in the unit to provide 5G broadband service to each device operated by one or more users. In some examples, FWA device 510, switch 512, GW/AP 520 may correspond with FWA device 310, switch 312, GW/AP 320 as illustrated in FIG. 3.

In some examples, switch 512 and/or FWA device 510 may determine the amount of data uploaded to and/or downloaded from the 5G network from any device in the multi-dwelling unit, based on the data received or transmitted by switch 512 and/or FWA device 510. For example, when FWA device 510 downloads 765 Gigabits (GB) of data in a time period, FWA device 510 may determine that amount of data is an amount of data for the multi-dwelling unit. switch 512 and/or FWA device 510 may be configured to generate a bill corresponding to the amount of data used by the multi-dwelling unit as a whole and transmit it to a third-party billing system for processing and distribution. The aggregated bill may be separated based on a predetermined percentage assigned to each unit (e.g., 5% of the bill, flat fee, etc.). In this example, neither the ISP 500 nor the multi-dwelling unit may act as the billing provider.

In some examples, a user of each GW/AP 520 may be charged depending on the speed that is being delivered to them. Alternative embodiments may include: a flat fee or combination of data used and flat fee by each GW/AP 520. For example, one customer within the MDU could pay for their usage based on usage (e.g., $29.99 per month for up to 5 GB of data and then pay for overages if they exceed the 5 GB) while another could pay more for an unlimited plan.

In some examples, users can avoid having to create separate accounts (based on each GW/AP 520) or rely on blind billing, since FWA device 510 is able to mete out service and users can be charged based on that traffic-shaped service that is determined for them.

In some examples, switch 512 and/or FWA device 510 may determine the quality of experience (QoE) of the user in order to generate the bill. For example, FWA device 510 may measure system, human, or contextual factors when providing data during a time period. When a QoE value corresponding with the system, human, or contextual factors exceeds a QoE threshold, FWA device 510 may determine that the QoE value is worth a particular amount used to generate a bill for the multi-dwelling unit or the building as a whole. As an illustrative example, the QoE value may correspond with the encoding, resolution, sample rate, etc. provided by the system or frequency of use of the user device in each unit. The QoE value may exceed a QoE threshold and switch 512 and/or FWA device 510 may generate/transmit a bill to a billing system (either third party or internal agent at each device, etc.) for processing and/or distribution.

Software agents may reside on switch 512 and/or FWA device 510, a cloud server, and GW/AP 520 to determine bandwidth and QoS provided to each GW/AP 520 using traffic shaping algorithm.

In some examples, either the switch 512 and/or FWA device 510 may be configured to start or stop access to a particular GW/AP 520 as a node on a particular communication path between the 5G network and the particular GW/AP 520.

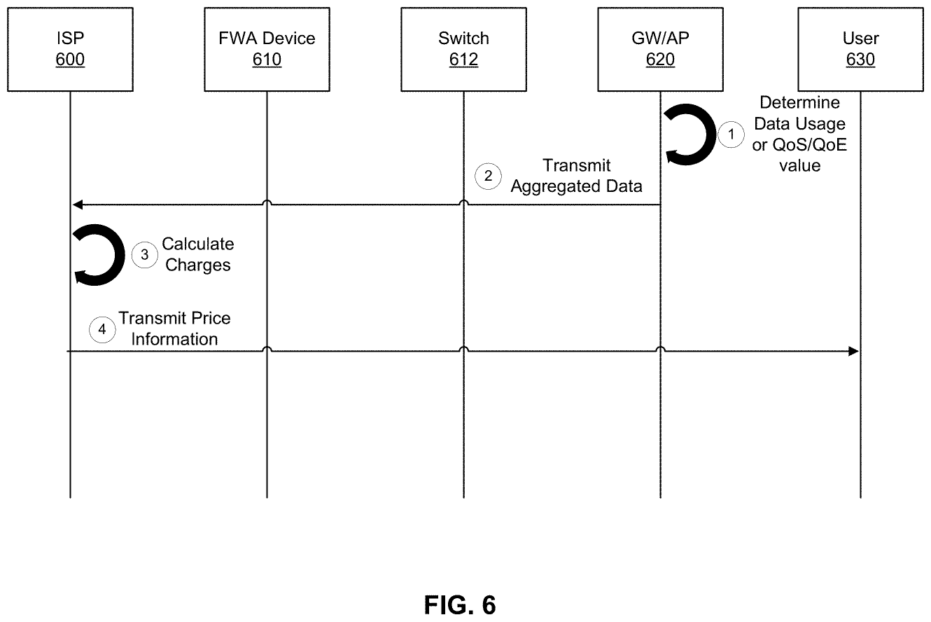

FIG. 6 comprises an alternative embodiment of a process for data usage in the multi-dwelling unit with which various embodiments may be implemented. A similar ISP 600, FWA device 610, switch 612, and GW/AP 620 may correspond with ISP 500, FWA device 510, switch 512, and GW/AP 520 as illustrated in FIG. 5. User 630 may be a person that operates a user device to access the 5G network via GW/AP 620.

At block 1 of FIG. 6, GW/AP 620 may determine a QoE value or an amount of data uploaded and/or downloaded from user devices that connect to the 5G network via GW/AP 620. GW/AP 620 may monitor each upload and/or download of data from individual user devices or other QoE value. The amount of data may be monitored by a software application installed in each GW/AP 620. Data may be tracked at an individual device level and aggregated, or may be determined in an aggregate level initially, such that a total value of data accessed via GW/AP 620 is determined.

In some examples, ISP 600 may apply a maximum data usage rate to each unit in the multi-dwelling unit. The calculation of the amount of data uploaded and/or downloaded from user devices that connect to the 5G network via GW/AP 620 may, in some examples, be subtracted from or calculated based on the maximum data usage.

In some examples, QoE may be considered. GW/AP 620 may determine the QoE value for one or more system, human, or contextual factors. As an illustrative example, GW/AP 620 may track the bandwidth or resolution (e.g., system factors), age, gender, or socio-cultural background (e.g., human factors from a user profile), and location, time of day, or frequency of use (e.g., contextual factors) corresponding with a user device accessing the 5G network. ISP 600 may allocate the capacity to the user and the traffic time ahead of time, and may implement real-time adjusting based on these or other QoE measurements.

At block 2, GW/AP 620 may transmit a value of the aggregated data or the QoE value to switch 612 and/or FWA device 610, which in turn is transmitted to ISP 600.

At block 3, ISP 600 may receive the value of the aggregated data or the QoE value and calculate charges corresponding with the value of the aggregated data that is used by user devices that connect to the 5G network via GW/AP 620. ISP 600 may also comprise a software application stored in memory to receive the aggregated data and calculate the charges. The charges may be aggregated for a time period (e.g., monthly, quarterly, etc.) and used to generate price information corresponding with the amount of data used. A similar process may the performed for each unit and corresponding GW/AP, as illustrated in FIG. 5, with a plurality of bills being generated by ISP 600.

At block 4, ISP 600 transmits the price information to the user associated with one or more user devices that connect through GW/AP 620 to access the 5G network. The transmission location may be stored locally with ISP 600 (e.g., via a registered account between ISP 600 and user 630).

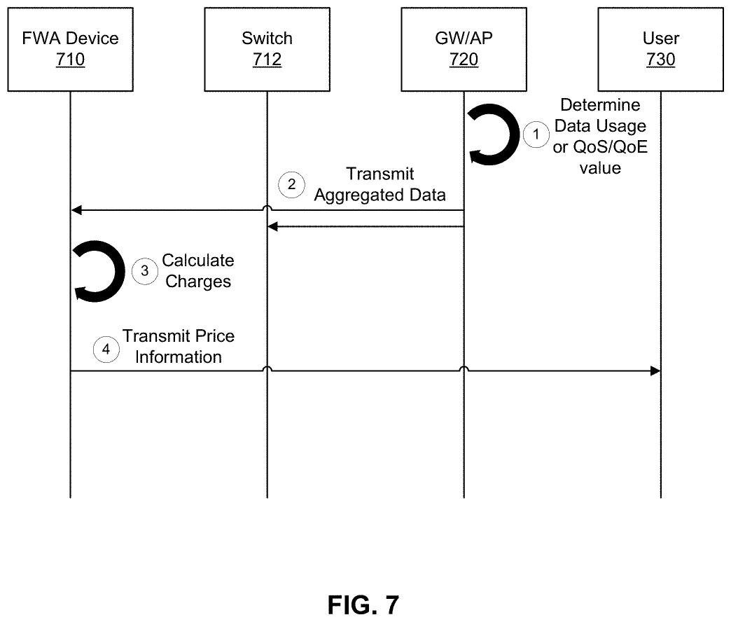

FIG. 7 illustrates an alternative process for data usage in the multi-dwelling unit with which various embodiments may be implemented. FWA device 710, switch 712, and GW/AP 720 may correspond with FWA device 510, switch 512, and GW/AP 520 as illustrated in FIG. 5. User 730 may be a person that operates a user device to access the 5G network via GW/AP 720. FWA device 710 may act as a virtual carrier to generate an invoice of charges corresponding with a the QoE value or data used by user devices that connect to the 5G network for each GW/AP 720.

At block 1, GW/AP 720 may determine the amount of data uploaded or downloaded from user devices that connect to the 5G network via GW/AP 720, or the QoE value as described herein.

At block 2, GW/AP 720 may transmit a value of the data to switch 712 and/or FWA device 710. Switch 712 and/or FWA device 710 may receive these values from each GW/AP 720 (e.g., first GW/AP 520A, second GW/AP 520B, third GW/AP 520C, fourth GW/AP 520D, fifth GW/AP 520E, sixth GW/AP 520F, etc.).

At block 3, switch 712 and/or FWA device 710 may calculate charges corresponding with the data used by user devices that connect to the 5G network for each GW/AP 720 or the QoE value. The charges may be aggregated for a time period (e.g., monthly, quarterly, etc.) and used to generate a bill corresponding with the amount of data used. A plurality of bills may be generated by switch 712 and/or FWA device 710, each of which correspond with each unit and GW/AP 520 illustrated in FIG. 5.

At block 4, switch 712 and/or FWA device 710 transmits the price information to the user associated with one or more user devices that connect through GW/AP 720 to access the 5G network. The transmission location may be stored locally with switch 712 and/or FWA device 710 (e.g., via a registered account between switch 712/FWA device 710 and user 730).

In this non-carrier billing scenario, a backend system (e.g., associated with FWA device 710) generates use data for each user 730 (e.g., per dwelling and/or building) and transmits it to the administrator of the backend system. This information may, in some examples, contain pre-calculated cost information or may be incorporated with pre-calculated cost information by the administrator after it is received. In some examples, the administrator can pass the pre-calculated cost information to each user 730 as part of their service agreement with each user 730 (e.g., included with monthly costs in the rental agreement or home owners association (HOA) fees, etc.). In some examples, the system may directly invoice each user 730 on the behalf of the administrator and track that they necessary payments have been received.

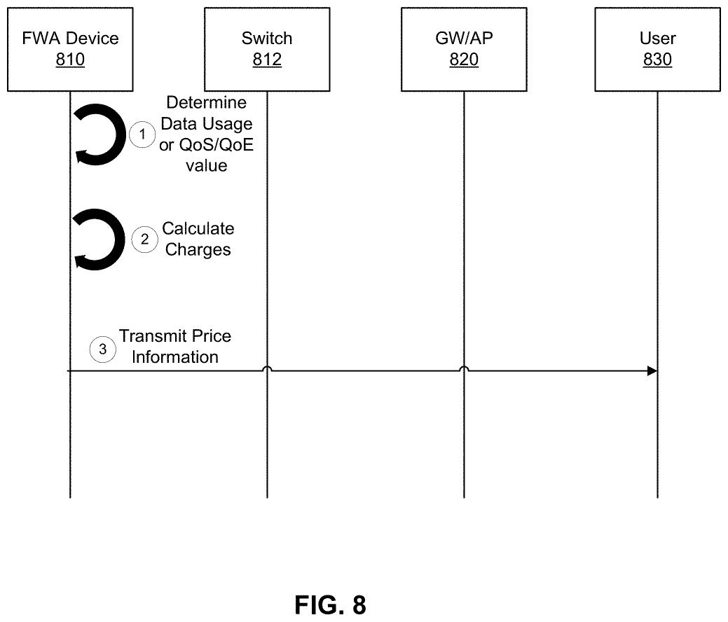

FIG. 8 illustrates an alternative process for data usage in the multi-dwelling unit with which various embodiments may be implemented. FWA device 810, switch 812, and GW/AP 820 may correspond with FWA device 510, switch 512, and GW/AP 520 as illustrated in FIG. 5. User 830 may be an administrative user that represents or is associated with the MDU.

At block 1, switch 812 and/or FWA device 810 may aggregate the values from each GW/AP 820 to determine a total amount of data used, QoE value, or QoS for the multi-dwelling unit.

At block 2, switch 812 and/or FWA device 810 may calculate charges corresponding with the data used by the multi-dwelling unit as a whole and generate a single bill for the multi-dwelling unit. The charges may be aggregated for a time period (e.g., monthly, quarterly, etc.) and used to generate a bill corresponding with the amount of data used.

When QoE is considered, switch 812 and/or FWA device 810 may determine the QoE value for one or more system, human, or contextual factors. As an illustrative example, switch 812 and/or FWA device 810 may track the bandwidth or resolution (e.g., system factors), age, gender, or socio-cultural background (e.g., human factors from a user profile), and location, time of day, or frequency of use (e.g., contextual factors) corresponding with a user device accessing the 5G network. Switch 812 and/or FWA device 810 may allocate the capacity to the user and the traffic time ahead of time, and may implement real-time adjusting based on these or other QoE measurements.

At block 3, switch 812 and/or FWA device 810 may transmit the aggregated price information for the MDU to administrative user 830. Administrative user 830 may divide the charges for the MDU as a whole amongst the units and/or charge a flat fee to each unit (corresponding with each GW/AP 820) for 5G network access. These individual bills or other pricing information may be distributed to the residents of the MDU associated with each GW/AP 820.

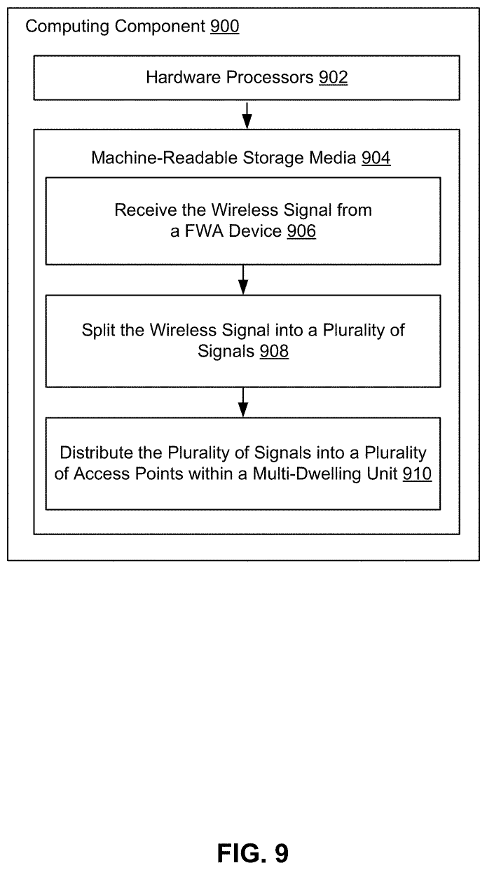

FIG. 9 is a block diagram of an example computing component or device 900 for providing 5G service management in a multi-dwelling unit in accordance with one embodiment. Computing component 900 may be, for example, a server computer, a controller, or any other similar computing component capable of processing data and measuring data usage, a QoE value, or QoS. For example, computing component 900 may be a processor of a user device or it may be an embodiment of processor 421. In the example implementation of FIG. 9, computing component 900 includes a hardware processor 902 and machine-readable storage medium 904.

Hardware processor 902 may be one or more Central Processing Units (CPUs), semiconductor-based microprocessors, and/or other hardware devices suitable for retrieval and execution of instructions stored in machine-readable storage medium, 904. Hardware processor 902 may fetch, decode, and execute instructions, such as instructions 906-910, to implement 5G service management in a multi-dwelling unit (MDU) in accordance with one embodiment. As an alternative or in addition to retrieving and executing instructions, hardware processor 902 may include one or more electronic circuits that include electronic components for performing the functionality of one or more instructions, such as a Field Programmable Gate Array (FPGA), Application Specific Integrated Circuit (ASIC), or other electronic circuits.

A machine-readable storage medium, such as machine-readable storage medium 904, may be any electronic, magnetic, optical, or other physical storage device that contains or stores executable instructions. Thus, machine-readable storage medium 904 may be, for example, Random Access Memory (RAM), Non-Volatile RAM (NVRAM), an Electrically Erasable Programmable Read-Only Memory (EEPROM), a storage device, an optical disc, and the like. In some embodiments, machine-readable storage medium 904 may be a non-transitory storage medium, where the term “non-transitory” does not encompass transitory propagating signals. As described in detail below, machine-readable storage medium 904 may be encoded with executable instructions, for example, instructions 906-910, which may be representative of an embodiment of the aforementioned self-installation application.

Hardware processor 902 may execute instruction 906 to receive the wireless signal from a FWA device.

Hardware processor 902 may execute instruction 908 to split the wireless signal into a plurality of signals.

Hardware processor 902 may execute instruction 910 to distribute the plurality of signals into a plurality of access points within a multi-dwelling unit.

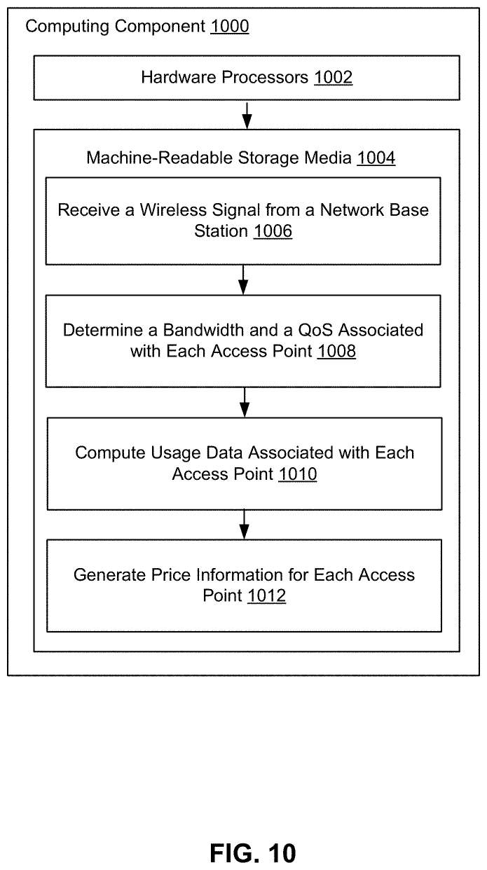

FIG. 10 is a block diagram of an example computing component or device 1000 for providing 5G service management in a multi-dwelling unit in accordance with one embodiment. Computing component 1000 may be, for example, a server computer, a controller, or any other similar computing component capable of processing data and measuring data usage, a QoE value, or QoS. For example, computing component 1000 may be a processor of a user device or it may be an embodiment of processor 421. In the example implementation of FIG. 10, computing component 1000 includes a hardware processor 1002 and machine-readable storage medium 1004.

Hardware processor 1002 may be one or more Central Processing Units (CPUs), semiconductor-based microprocessors, and/or other hardware devices suitable for retrieval and execution of instructions stored in machine-readable storage medium, 1004. Hardware processor 1002 may fetch, decode, and execute instructions, such as instructions 1006-1012, to implement 5G service management in a multi-dwelling unit (MDU) in accordance with one embodiment. As an alternative or in addition to retrieving and executing instructions, hardware processor 1002 may include one or more electronic circuits that include electronic components for performing the functionality of one or more instructions, such as a Field Programmable Gate Array (FPGA), Application Specific Integrated Circuit (ASIC), or other electronic circuits.

A machine-readable storage medium, such as machine-readable storage medium 1004, may be any electronic, magnetic, optical, or other physical storage device that contains or stores executable instructions. Thus, machine-readable storage medium 1004 may be, for example, Random Access Memory (RAM), Non-Volatile RAM (NVRAM), an Electrically Erasable Programmable Read-Only Memory (EEPROM), a storage device, an optical disc, and the like. In some embodiments, machine-readable storage medium 1004 may be a non-transitory storage medium, where the term “non-transitory” does not encompass transitory propagating signals. As described in detail below, machine-readable storage medium 904 may be encoded with executable instructions, for example, instructions 1006-1012, which may be representative of an embodiment of the aforementioned self-installation application.

Hardware processor 1002 may execute instruction 1006 to receive the wireless signal from a network base station.

Hardware processor 1002 may execute instruction 1008 to determine a bandwidth and a QoS associated with each access point. For example, the FWA may be configured to determine, based on a traffic shaping algorithm, a bandwidth and a Quality of Service (QoS) associated with each access point of a plurality of access points.

Hardware processor 1002 may execute instruction 1010 to compute usage data associated with each access point. For example, the FWA may be configured to compute, based on the determined bandwidth and the determined QoS, usage data associated with each access point of the plurality of access points.

Hardware processor 1002 may execute instruction 1012 to generate price information for each access point. For example, the FWA may be configured to generate, based on the computed usage data, price information for each access point of the plurality of access points.

In some examples, the switch is configured to receive the wireless signal from the FWA device, split the wireless signal into a plurality of signals, and distribute the plurality of signals into a plurality of access points within the MDU.

In some examples, the FWA device transmits the price information to a billing system of an internet service provider (ISP).

In some examples, the plurality of access points transmit the bandwidth or a QoE value to the FWA device.

In some examples, the FWA device acts as a virtual carrier to generate an invoice for the plurality of access points.

In some examples, the price information is combined with pre-calculated cost information to generate an invoice for each of the plurality of access points.

In some examples, the price information for each access point of the plurality of access points is aggregated by the FWA device and divided by an administrative user for one or more units in the MDU.

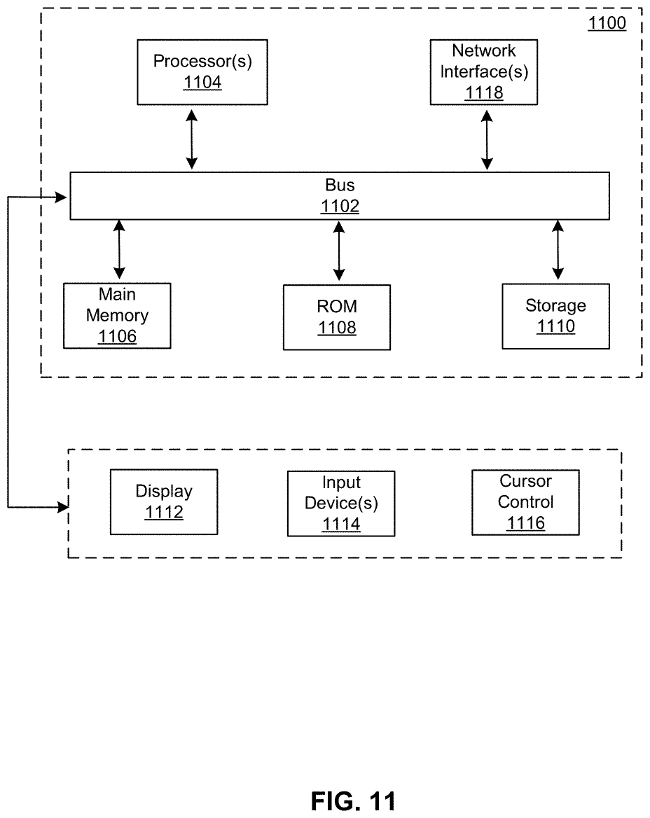

FIG. 11 depicts a block diagram of an example computer system 1100 in which various of the embodiments described herein may be implemented. The computer system 1100 includes a bus 1102 or other communication mechanism for communicating information, one or more hardware processors 1104 coupled with bus 1102 for processing information. Hardware processor(s) 1104 may be, for example, one or more general purpose microprocessors.

The computer system 1100 also includes a main memory 1106, such as a Random Access Memory (RAM), cache and/or other dynamic storage devices, coupled to bus 1102 for storing information and instructions to be executed by processor 1104. Main memory 1106 also may be used for storing temporary variables or other intermediate information during execution of instructions to be executed by processor 1104. Such instructions, when stored in storage media accessible to processor 1104, render computer system 1100 into a special-purpose machine that is customized to perform the operations specified in the instructions.

The computer system 1100 further includes a Read Only Memory (ROM) 1108 or other static storage device coupled to bus 1102 for storing static information and instructions for processor 1104. A storage device 1110, such as a magnetic disk, optical disk, or USB thumb drive (Flash drive), etc., is provided and coupled to bus 1102 for storing information and instructions. Also coupled to bus 1102 are a display 1112 for displaying various information, data, media, etc., input device(s) 1114 for allowing a user of computer system 1100 to control, manipulate, and/or interact with computer system 1100. One manner of interaction may be through a cursor control 1116, such as a computer mouse or similar control/navigation mechanism.

In general, the word “engine,” “component,” “system,” “database,” and the like, as used herein, can refer to logic embodied in hardware or firmware, or to a collection of software instructions, possibly having entry and exit points, written in a programming language, such as, for example, Java, C, or C++. A software component may be compiled and linked into an executable program, installed in a dynamic link library, or may be written in an interpreted programming language such as, for example, BASIC, Perl, or Python. It will be appreciated that software components may be callable from other components or from themselves, and/or may be invoked in response to detected events or interrupts. Software components configured for execution on computing devices may be provided on a computer readable medium, such as a compact disc, digital video disc, flash drive, magnetic disc, or any other tangible medium, or as a digital download (and may be originally stored in a compressed or installable format that requires installation, decompression or decryption prior to execution). Such software code may be stored, partially or fully, on a memory device of the executing computing device, for execution by the computing device. Software instructions may be embedded in firmware, such as an EPROM. It will be further appreciated that hardware components may be comprised of connected logic units, such as gates and flip-flops, and/or may be comprised of programmable units, such as programmable gate arrays or processors.

The computer system 1100 may implement the techniques described herein using customized hard-wired logic, one or more ASICs or FPGAs, firmware and/or program logic which in combination with the computer system causes or programs computer system 1100 to be a special-purpose machine. According to one embodiment, the techniques herein are performed by computer system 1100 in response to processor(s) 1104 executing one or more sequences of one or more instructions contained in main memory 1106. Such instructions may be read into main memory 1106 from another storage medium, such as storage device 1110. Execution of the sequences of instructions contained in main memory 1106 causes processor(s) 1104 to perform the process steps described herein. In alternative embodiments, hard-wired circuitry may be used in place of or in combination with software instructions.

The term “non-transitory media,” and similar terms, as used herein refers to any media that store data and/or instructions that cause a machine to operate in a specific fashion. Such non-transitory media may comprise non-volatile media and/or volatile media. Non-volatile media includes, for example, optical or magnetic disks, such as storage device 1110. Volatile media includes dynamic memory, such as main memory 1106. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, and networked versions of the same.

Non-transitory media is distinct from but may be used in conjunction with transmission media. Transmission media participates in transferring information between non-transitory media. For example, transmission media includes coaxial cables, copper wire and fiber optics, including the wires that comprise bus 1102. Transmission media can also take the form of acoustic or light waves, such as those generated during radio-wave and infra-red data communications.

As used herein, the term “or” may be construed in either an inclusive or exclusive sense. Moreover, the description of resources, operations, or structures in the singular shall not be read to exclude the plural. Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Terms and phrases used in this document, and variations thereof, unless otherwise expressly stated, should be construed as open ended as opposed to limiting. As examples of the foregoing, the term “including” should be read as meaning “including, without limitation” or the like. The term “example” is used to provide exemplary instances of the item in discussion, not an exhaustive or limiting list thereof. The terms “a” or “an” should be read as meaning “at least one,” “one or more” or the like. The presence of broadening words and phrases such as “one or more,” “at least,” “but not limited to” or other like phrases in some instances shall not be read to mean that the narrower case is intended or required in instances where such broadening phrases may be absent.

While various embodiments of the disclosed technology have been described above, it should be understood that they have been presented by way of example only, and not of limitation. Likewise, the various diagrams may depict an example architectural or other configuration for the disclosed technology, which is done to aid in understanding the features and functionality that can be included in the disclosed technology. The disclosed technology is not restricted to the illustrated example architectures or configurations, but the desired features can be implemented using a variety of alternative architectures and configurations. Indeed, it will be apparent to one of skill in the art how alternative functional, logical or physical partitioning and configurations can be implemented to implement the desired features of the technology disclosed herein. Also, a multitude of different constituent module names other than those depicted herein can be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the disclosed technology is described above in terms of various example embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the disclosed technology, whether or not such embodiments are described and whether or not such features are presented as being a part of a described embodiment. Thus, the breadth and scope of the technology disclosed herein should not be limited by any of the above-described example embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

Additionally, the various embodiments set forth herein are described in terms of example block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A billing and service management system in a Multi-Dwelling Unit (MDU), comprising:
a Fixed Wireless Access (FWA) device is coupled with a switch, wherein the FWA device is configured to:
receive a wireless signal from a network base station;
determine, based on a traffic shaping algorithm, a bandwidth and a Quality of Service (QoS) associated with each access point of a plurality of access points;
compute, based on the determined bandwidth and the determined QoS, usage data associated with each access point of the plurality of access points; and
generate, based on the computed usage data, price information for each access point of the plurality of access points.

2. The billing and service management system in the MDU of claim 1, wherein the switch is configured to:
receive the wireless signal from the FWA device;
split the wireless signal into a plurality of signals; and
distribute the plurality of signals into a plurality of access points within the MDU.

3. The billing and service management system in the MDU of claim 1, wherein the FWA device transmits the price information to a billing system of an internet service provider (ISP).

4. The billing and service management system in the MDU of claim 1, wherein the plurality of access points transmit the bandwidth or a QoE value to the FWA device.

5. The billing and service management system in the MDU of claim 1, wherein the FWA device acts as a virtual carrier to generate an invoice for the plurality of access points.

6. The billing and service management system in the MDU of claim 1, wherein the price information is combined with pre-calculated cost information to generate an invoice for each of the plurality of access points.

7. The billing and service management system in the MDU of claim 1, wherein the price information for each access point of the plurality of access points is aggregated by the FWA device and divided by an administrative user for one or more units in the MDU.

8. A computer-implemented method of providing a billing and service management system in a Multi-Dwelling Unit (MDU), the method comprising:
receiving, by a Fixed Wireless Access (FWA) device coupled with a switch, a wireless signal from a network base station;
determining, based on a traffic shaping algorithm, a bandwidth and a Quality of Service (QoS) associated with each access point of a plurality of access points;
computing, based on the determined bandwidth and the determined QoS, usage data associated with each access point of the plurality of access points; and
generating, based on the computed usage data, price information for each access point of the plurality of access points.

9. The computer-implemented method of claim 8, further comprising:
receiving, by the switch, the wireless signal from the FWA device;
splitting, by the switch, the wireless signal into a plurality of signals; and
distributing, by the switch, the plurality of signals into a plurality of access points within the MDU.

10. The computer-implemented method of claim 8, wherein the FWA device transmits the price information to a billing system of an internet service provider (ISP).

11. The computer-implemented method of claim 8, wherein the plurality of access points transmit the bandwidth or a QoE value to the FWA device.

12. The computer-implemented method of claim 8, wherein the FWA device acts as a virtual carrier to generate an invoice for the plurality of access points.

13. The computer-implemented method of claim 8, wherein the price information is combined with pre-calculated cost information to generate an invoice for each of the plurality of access points.

14. The computer-implemented method of claim 8, wherein the price information for each access point of the plurality of access points is aggregated by the FWA device and divided by an administrative user for one or more units in the MDU.

15. A non-transitory computer-readable storage medium storing a plurality of instructions executable by one or more processors, the plurality of instructions when executed by the one or more processors of a Fixed Wireless Access (FWA) device coupled with a switch that cause the one or more processors to:
receive a wireless signal from a network base station;
determine, based on a traffic shaping algorithm, a bandwidth and a Quality of Service (QoS) associated with each access point of a plurality of access points;
compute, based on the determined bandwidth and the determined QoS, usage data associated with each access point of the plurality of access points; and
generate, based on the computed usage data, price information for each access point of the plurality of access points.

16. The computer-readable storage medium of claim 15, wherein the FWA device transmits the price information to a billing system of an internet service provider (ISP).

17. The computer-readable storage medium of claim 15, wherein the plurality of access points transmit the bandwidth or a QoE value to the FWA device.

18. The computer-readable storage medium of claim 15, wherein the FWA device acts as a virtual carrier to generate an invoice for the plurality of access points.

19. The computer-readable storage medium of claim 15, wherein the price information is combined with pre-calculated cost information to generate an invoice for each of the plurality of access points.

20. The computer-readable storage medium of claim 15, wherein the price information for each access point of the plurality of access points is aggregated by the FWA device and divided by an administrative user for one or more units in the MDU.
